(19) United States
(12) Patent Application Publication
(10) Pub. No.: US 2026/0185337 A1
(43) Pub. Date: Jul. 2, 2026

(54) SYSTEM AND METHOD FOR CONTROLLING WATER TEMPERATURE

(71) Applicant: Delta Faucet Company, Indianapolis, IN (US)

(72) Inventor: Joel D. Sawaski, Indianapolis, IN (US)

(21) Appl. No.: 19/434,661

(22) Filed: Dec. 29, 2025

Related U.S. Application Data
(60) Provisional application No. 63/740,026, filed on Dec. 30, 2024.

(51) Int. Cl. E03C 1/05; E03C 1/04; G01K 13/02

(52) U.S. Cl. CPC E03C 1/055; E03C 1/0408; G01K 13/026

(57) ABSTRACT

An electronic shower system includes at least one valve fluidly coupled to a hot water supply and a cold water supply. A temperature measuring circuit measures the temperature of water supplied by the at least one valve. The temperature measuring circuit has a known initial thermal time constant. An electronic user interface presents information to a human user. A controller is in electrical communication with the temperature measuring circuit and with the electronic user interface. The controller receives a plurality of temperature measurements from the temperature measuring circuit, and calculates a current thermal time constant of the temperature measuring circuit based on the temperature measurements. If the current thermal time constant differs from the initial thermal time constant by more than a threshold amount, the controller causes the electronic user interface to notify the human user that the temperature measuring circuit is in need of maintenance. If the current thermal time constant does not differ from the initial thermal time constant by more than a threshold amount, the controller does not cause the electronic user interface to notify the human user that the temperature measuring circuit is in need of maintenance.

### CROSS-REFERENCE TO RELATED APPLICATION

The present application claims priority to U.S. Provisional Patent Application Ser. No. 63/740,026, filed Dec. 30, 2024, the disclosure of which is expressly incorporated herein by reference.

### BACKGROUND AND SUMMARY OF THE INVENTION

The present invention relates generally to an electronic shower system and, more particularly, to an electronic shower system including a user interface operably coupled to a controller for controlling the temperature of water delivered to at least one water outlet.

The performance of a temperature control system is dependent on the response time of the temperature measurement device used by the system. The thermal time constant of a thermistor, also referred to as a time constant, time response or Tau (τ), may be defined as the time it takes for the temperature measurement output of the thermistor to reach 63.2% of the way from its initial temperature measurement output to its final temperature measurement output after a step change in a parameter that changes a steady-state temperature or “final” temperature of the thermistor. In other words, it is the e-folding time: 63.2%=1−1/e.

The classical way to determine this time response t is to measure three values: initial temperature, final temperature, and time taken to arrive at the 63.2% temperature value. This method is easily performed in a lab situation but difficult to do in a faucet or shower product. The method can be performed, but a special sequence would be needed for the system. While the method is being performed, the user would not have access to the product.

Current systems assume an average value for Tau. This assumption causes slower responding (overdamped) system if the assumption is too low. It also causes oscillating systems (underdamped) if the assumed value of Tau is too high. This effect is minimized by using temperature elements that have a small tolerance for Tau. The best system performance occurs when the Tau value is known, not assumed. The present disclosure provides a way to monitor Tau in the system with little to no impact on the user's normal usage. This method can also be used to track Tau over the life of a product.

By using mathematical techniques based on Newton's Law of Cooling, different formulas can be derived to measure Tau without knowing both initial and final temperatures. In one method, the temperature at two points in time and the final temperature value must be measured and/or known, and this may be referred to herein as “the two-point method.” In another method, the temperature at three points in time must be measured, and this may be referred to herein as “the three-point method.” The three-point method may be preferred over the two-point method, but noise may be an issue with the three-point method. However, by performing the three-point method multiple times during a 0.5 second period and averaging the multiple Tau measurements, it has been found that problems with noise may be mostly overcome.

The temperature measurements based upon which Tau is calculated may be taken when water is flowing or may be taken when water is not flowing. However, no parameter that affects the final temperature should be changed in the time periods between the temperature measurements. For example, water flow should not be turned on or off between temperature measurements. Nor should the mix between, or proportions of, cold water and hot water be changed between temperature measurements.

Solving for Tau may facilitate thermistor testing. According to the invention, Tau may be measured periodically throughout the life of the water delivery system. If Tau changes more than a threshold amount during the life of the water delivery system, it may indicate that some component within the water delivery system is in need of repair. The controller can then notify the user through the electronic user interface that the repair is needed. A change in Tau may indicate that something in the measuring circuit has changed. For example, cabling may have degraded; there may be corrosion on a connector; a crimped connection may be loosening; or there may be scale buildup on the thermistor. All of these conditions may call for repair in order to improve the safety of the water delivery system (e.g., reduce the chances of a user burning himself with hot water).

According to an illustrative embodiment of the present disclosure, the electronic shower system includes at least one valve fluidly coupled to a hot water supply and a cold water supply. A temperature measuring circuit measures the temperature of water supplied by the at least one valve. The temperature measuring circuit has a known initial thermal time constant. An electronic user interface presents information to a human user. A controller is in electrical communication with the temperature measuring circuit and with the electronic user interface. The controller receives a plurality of temperature measurements from the temperature measuring circuit, and calculates a current thermal time constant of the temperature measuring circuit based on the temperature measurements. If the current thermal time constant differs from the initial thermal time constant by more than a threshold amount, the controller causes the electronic user interface to notify the human user that the temperature measuring circuit is in need of maintenance. If the current thermal time constant does not differ from the initial thermal time constant by more than a threshold amount, the controller does not cause the electronic user interface to notify the human user that the temperature measuring circuit is in need of maintenance. The current thermal time constant of the temperature measuring circuit may be calculated based on temperature measurements made within a predetermined period of time, illustratively approximately between 0.5 seconds and 1.5 seconds in length.

According to an illustrative embodiment of the present disclosure, a method of operating an electronic shower system includes using a temperature measuring circuit to make a plurality of temperature measurements at the output of at least one valve. The temperature measuring circuit has a known initial thermal time constant. A current thermal time constant of the temperature measuring circuit is calculated based on the temperature measurements. The current thermal time constant is compared to the initial thermal time constant. A human user is notified that the temperature measuring circuit is in need of maintenance. However, this notifying step is performed only if the comparing step indicates that the current thermal time constant differs from the initial thermal time constant by more than a threshold amount.

According to yet another illustrative embodiment of the present disclosure, an electronic shower system includes at least one valve fluidly coupled to a hot water supply and a cold water supply. A temperature measuring circuit measures the temperature of water supplied by the at least one valve. An electronic user interface presents information to a human user. A controller is in electrical communication with the temperature measuring circuit and with the electronic user interface. The controller periodically receives a plurality of temperature measurements from the temperature measuring circuit over a lifetime of the temperature measuring circuit, and periodically calculates a thermal time constant of the temperature measuring circuit based on the temperature measurements. The controller compares a most recently calculated thermal time constant of the temperature measuring circuit to at least one previously calculated thermal time constant of the temperature measuring circuit. If the most currently calculated thermal time constant differs from the at least one previously calculated thermal time constant by more than a threshold amount, then the controller causes the electronic user interface to notify the human user that the temperature measuring circuit is in need of maintenance. If the most currently calculated thermal time constant does not differ from the at least one previously calculated thermal time constant by more than the threshold amount, then the controller refrains from causing the electronic user interface to notify the human user that the temperature measuring circuit is in need of maintenance.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic view of an illustrative electronic shower system of the present disclosure; and

FIG. 2 is a perspective view of the electronic shower system of FIG. 1, shown installed in a shower enclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

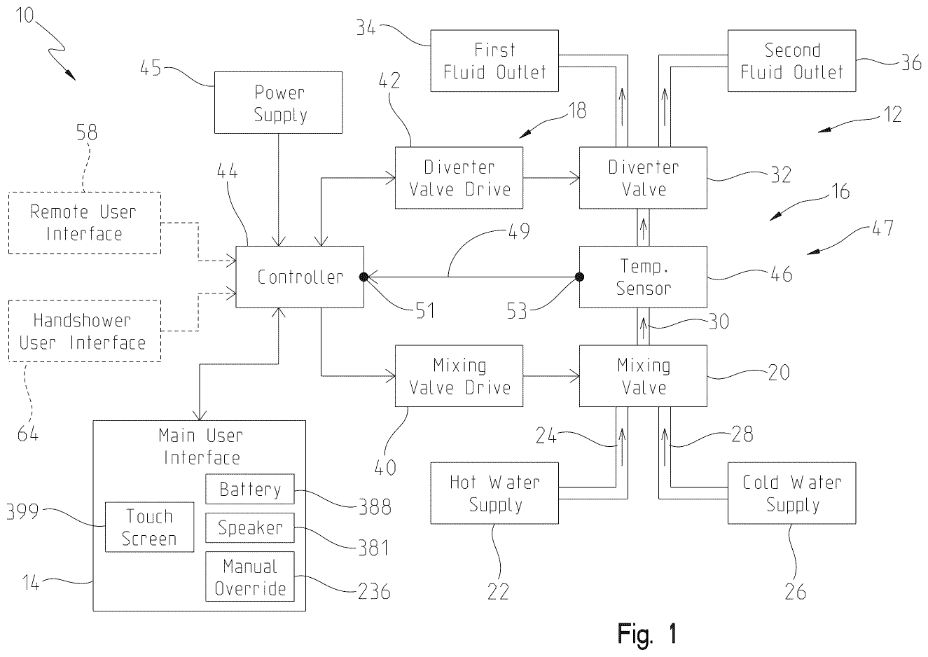

Referring initially to FIG. 1, an electronic shower system 10 is shown as including a flow control assembly 12 and a main user interface 14 operably coupled to the flow control assembly 12. The flow control assembly 12 illustratively includes a valve assembly 16 operably coupled to a drive assembly 18.

The valve assembly 16 illustratively includes a proportioning mixing valve 20 fluidly coupled to a hot water supply 22 through a hot water inlet conduit 24, and to a cold water supply 26 through a cold water inlet conduit 28. As is known and further detailed herein, the illustrative mixing valve 20 includes a movable valve member (e.g. a rotatable valve plate or disc) configured to control the flow of hot water and cold water (including the relative proportions therebetween) supplied to a mixed water outlet 30.

A diverter valve 32 is fluidly coupled to the mixing valve 20 through the mixed water outlet 30. The diverter valve 32 is configured to control the flow of water from the mixed water outlet 30 to a first fluid outlet 34 and a second fluid outlet 36. More particularly, the diverter valve 32 directs water selectively to one or both of the outlets 34 and 36. The diverter valve 32 may also control the rate of water flow to the selected outlet(s) 34 and 36.

The drive assembly 18 illustratively includes a mixing valve drive 40 and a diverter valve drive 42. The mixing valve 20 is operably coupled to the mixing valve drive 40, and the diverter valve 32 is operably coupled to the diverter valve drive 42. A controller 44 is in communication with both the mixing valve drive 40 and the diverter valve drive 42. More particularly, the controller 44 communicates with the user interfaces (including main user interface 14) and controls operation of the mixing valve drive 40 and the diverter valve drive 42 and, hence, the mixing valve 20 and the diverter valve 32, respectively. Controller 44 may be of conventional design as illustratively including a microprocessor and a memory for processing and storing data. An external power supply 45 is coupled to the controller 44. As further detailed herein, the controller 44 is configured to detect when power is being provided to the system 10 by external power supply 45.

A temperature measuring circuit 47 includes a temperature sensor 46; an electrical conductor 49 carrying temperature measurement signals from sensor 46 to controller 44; a first connector 51 connecting controller 44 to conductor 49; and a second connector 53 connecting sensor 46 to conductor 49. Temperature sensor 46 may be in the form of a thermistor, and is configured to measure the temperature of water within the mixed water outlet 30 after exiting from the mixing valve 20.

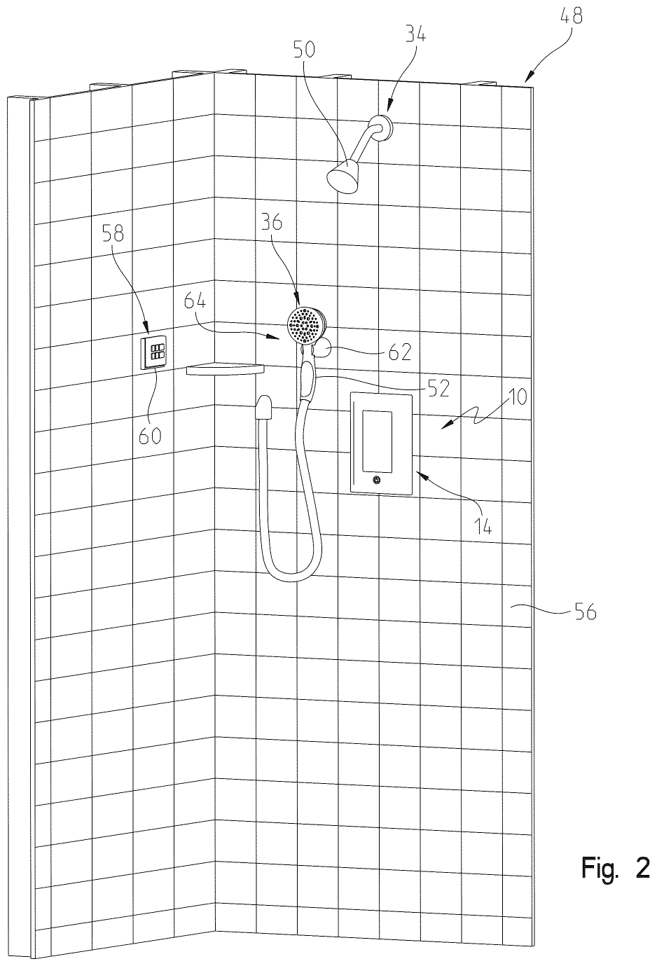

As shown in FIG. 2, the electronic shower system 10 may be received within a conventional shower enclosure 48, wherein the first fluid outlet 34 comprises an overhead showerhead 50 and the second fluid outlet 36 comprises a hand shower 52. The main user interface 14 may be coupled to a vertical shower wall 56 and is in communication with the controller 44. In certain illustrative embodiments, the controller 44 may be received within the main user interface 54. A remote user interface 58 may be in wireless communication with the controller 44 and removably coupled to a bracket 60 supported by the shower wall 56. The hand shower 52 may be removably coupled to a cradle 62 supported by the shower wall 56. In certain illustrative embodiments, the hand shower 52 may include a user interface 64 in wireless communication with the main controller 44.

As described above, the time constant Tau (τ) is defined by an exponential temperature function. The time constant Tau (τ) may be calculated as a function of the final temperature, the two arbitrary temperature measurement points on the exponential graph, and the time between the temperature measurement points. It is not necessary to wait for and measure a final temperature, however, as the final temperature may be calculated based on the two temperature measurements. The following is a method for determining the final (i.e., terminal) level (value at time=infinity) of an exponential function knowing any two arbitrary points on the graph and the time between the points. It is not needed to know the starting level (initial value) of the exponential function. The time constant Tau (t) may then be calculated as a function of the final level, the two arbitrary points on the graph and the time between the points.

Not all solution steps are shown below. Only significant steps are listed to enable one of ordinary skill in the art to practice the invention.

General Equation ƒ(t)=F−(F−S)e^{-t/τ} where F is the final temperature value and S is the starting temperature value. Temperatures ƒ(t) may be measured by temperature sensor 46 at arbitrary times between which no parameters that would affect the final temperature F have been changed. For example, no changes in the position of mixing valve 20 should be made between temperature measurements, as such changes could turn on the flow of water, turn off the flow of water, or change the proportion of hot water to cold water in the flow.

### Solve for S

$$S = \frac{f ( t ) - F + {Fe}^{- t {/}_{τ}}}{{e}^{- t {/}_{τ}}}$$

Point 1 on graph ƒ(t₁)=F−(F−S)e^{-t}^{₁}^{/τ} Ordered pair (t₁, ƒ(t₁))
Point 2 on graph ƒ(t₂)=F−(F−S)e^{-t}^{₂}^{/τ} Ordered pair (t₂, ƒ(t₂))

### Solve for S Set Equal

$$\frac{f ( {t}_{1} ) - F + {Fe}^{- {t}_{1} {/}_{τ}}}{{e}^{- {t}_{1} {/}_{τ}}} = \frac{f ( {t}_{2} ) - F + {Fe}^{- {t}_{2} {/}_{τ}}}{{e}^{- {t}_{2} {/}_{τ}}}$$

### Solve for F

$$F = \frac{f ( {t}_{1} ) - f ( {t}_{2} ) {e}^{( {t}_{2} - {t}_{1} ) {/}_{τ}}}{1 - {e}^{( {t}_{2} - {t}_{1} ) {/}_{τ}}}$$

### Solve for T

$$τ = \frac{{t}_{1} - {t}_{2}}{ln \frac{F - f ( {t}_{1} )}{F - f ( {t}_{2} )}}$$

$$τ = \frac{{t}_{1} - {t}_{2}}{ln \frac{F - f ( {t}_{1} )}{F - f ( {t}_{2} )} ln \frac{F - f ( {t}_{2} )}{F - f ( {t}_{3} )}}$$

$$F = \frac{f ( {t}_{2} ) f ( {t}_{2} ) - f ( {t}_{1} ) f ( {t}_{3} )}{f ( {t}_{1} ) + f ( {t}_{3} ) - 2 f ( {t}_{2} )}$$

$${t}_{1} - {t}_{2} = {t}_{2} - {t}_{3}$$

$$F = \frac{f ( {t}_{2} ) f ( {t}_{2} ) - f ( {t}_{1} ) f ( {t}_{3} )}{f ( {t}_{1} ) + f ( {t}_{3} ) - 2 f ( {t}_{2} )}$$

$$τ = \frac{{t}_{1} - {t}_{2}}{ln \frac{f ( {t}_{1} ) - f ( {t}_{2} )}{f ( {t}_{2} ) - f ( {t}_{3} )}}$$

$${t}_{1} - {t}_{2} = {t}_{2} - {t}_{3}$$

The above description outlines one example method of calculating the time constant Tau based on time and temperature measurements. It is to be understood, however, that there are other methods within the scope of the invention to calculate the time constant Tau based on time and temperature measurements.

The current thermal time constant of the temperature measuring circuit may be calculated based on temperature measurements made within a predetermined period of time, illustratively approximately between 0.5 seconds and 1.5 seconds in length. This period of time may be short enough that the user is unlikely to make any changes in the position of mixing valve 20 between temperature measurements. However, if it is sensed that the user has changed the position of mixing valve 20 between temperature measurements, then the temperature measurements may be retaken, and the time constant may be calculated based on the newly taken temperature measurements.

The current value of Tau associated with temperature measuring circuit 47 as calculated above may be compared with previously known or calculated values of Tau. If controller 44 determines that the current value of Tau differs from the previous values of Tau by more than some threshold amount, then it can be assumed that some part of temperature measuring circuit 47 has degraded and is in need of repair or replacement. The controller 44 may then use user interface 14 to inform a human user that some part of temperature measuring circuit 47 is in need of repair or replacement. For example, an audible message may be played on speaker 381, a text message may be displayed on touch screen 399, and/or a light emitting device (not shown) such as a light emitting diode (LED) may become illuminated or lit.

The illustrative system of the present disclosure has been described as including a mixing valve to combine water from a hot water supply with water from a cold water supply. However, it is within the scope of the disclosure for the system to utilize other types of valves including, for example, an electrically operable hot water valve and a separate electrically operable cold water valve instead of a mixing valve.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An electronic shower system comprising:
At least one valve fluidly coupled to a hot water supply and a cold water supply;
a temperature measuring circuit configured to measure the temperature of water supplied by the at least one valve, the temperature measuring circuit having a known initial thermal time constant;
an electronic user interface configured to present information to a human user; and
a controller in electrical communication with the temperature measuring circuit and with the electronic user interface, the controller being configured to:
receive a plurality of temperature measurements from the temperature measuring circuit;
calculate a current thermal time constant of the temperature measuring circuit based on the temperature measurements; and
only if the current thermal time constant differs from the initial thermal time constant by more than a threshold amount, cause the electronic user interface to notify the human user that the temperature measuring circuit is in need of maintenance.

2. The electronic shower system of claim 1, wherein the temperature measuring circuit includes a thermistor.

3. The electronic shower system of claim 1, wherein the known initial thermal time constant is a thermal time constant that has been previously calculated by the controller.

4. The electronic shower system of claim 1, wherein the temperature measurements are made while water is flowing through the at least one valve.

5. The electronic shower system of claim 1, wherein the temperature measurements are made without water flowing through the at least one valve.

6. The electronic shower system of claim 1, wherein the at least one valve comprises a mixing valve.

7. The electronic shower system of claim 1, wherein the controller is configured to calculate the current thermal time constant of the temperature measuring circuit based on temperature measurements made within a predetermined period of time.

8. The electronic shower system of claim 7, wherein the predetermined period of time is approximately between 0.5 seconds and 1.5 seconds.

9. The electronic shower system of claim 7, wherein the controller is configured to calculate the current thermal time constant of the temperature measuring circuit dependent upon at least one period of time between the temperature measurements.

10. A method of operating an electronic shower system, the method comprising the computer-implemented steps of:
using a temperature measuring circuit to make a plurality of temperature measurements at the output of at least one valve, the temperature measuring circuit having a known initial thermal time constant;
calculating a current thermal time constant of the temperature measuring circuit based on the temperature measurements;
comparing the current thermal time constant to the initial thermal time constant; and
notifying a human user that the temperature measuring circuit is in need of maintenance, the notifying step being performed only if the comparing step indicates that the current thermal time constant differs from the initial thermal time constant by more than a threshold amount.

11. The method of claim 10, wherein the temperature measuring circuit includes a thermistor.

12. The method of claim 10, wherein the known initial thermal time constant is a thermal time constant that has been previously calculated locally by the electronic shower system.

13. The method of claim 10, wherein the current thermal time constant of the temperature measuring circuit is calculated based on temperature measurements made within a predetermined period of time.

14. The method of claim 13, wherein the current thermal time constant of the temperature measuring circuit is calculated dependent upon at least one period of time between the temperature measurements.

15. The method of claim 10, wherein the current thermal time constant of the temperature measuring circuit is calculated based on temperature measurements made within a period of time of approximately between 0.5 seconds and 1.5 seconds.

16. The method of claim 10, wherein the temperature measurements are made while water is flowing through the at least one valve.

17. The method of claim 10, wherein the temperature measurements are made without water flowing through the at least one valve.

18. The method of claim 10, wherein each of the steps of the method are performed within and by the electronic shower system.

19. The method of claim 10, wherein the at least one valve comprises a mixing valve.

20. An electronic shower system comprising:
at least one valve fluidly coupled to a hot water supply and a cold water supply;
a temperature measuring circuit configured to measure the temperature of water supplied by the at least one valve;
an electronic user interface configured to present information to a human user; and
a controller in electrical communication with the temperature measuring circuit and with the electronic user interface, the controller being configured to:
periodically receive a plurality of temperature measurements from the temperature measuring circuit over a lifetime of the temperature measuring circuit;
periodically calculate a thermal time constant of the temperature measuring circuit based on the temperature measurements;
compare a most recently calculated thermal time constant of the temperature measuring circuit to at least one previously calculated thermal time constant of the temperature measuring circuit;
if the most currently calculated thermal time constant differs from the at least one previously calculated thermal time constant by more than a threshold amount, then cause the electronic user interface to notify the human user that the temperature measuring circuit is in need of maintenance; and
if the most currently calculated thermal time constant does not differ from the at least one previously calculated thermal time constant by more than the threshold amount, then refrain from causing the electronic user interface to notify the human user that the temperature measuring circuit is in need of maintenance.

21. The electronic shower system of claim 20, wherein the temperature measuring circuit includes a thermistor.

22. The electronic shower system of claim 20, wherein the controller is configured to calculate the current thermal time constant of the temperature measuring circuit based on temperature measurements made within a period of time between approximately 0.5 seconds and 1.5 seconds.

23. The electronic shower system of claim 22, wherein the controller is configured to calculate the current thermal time constant of the temperature measuring circuit dependent upon at least one period of time between the temperature measurements.

24. The electronic shower system of claim 20, wherein the temperature measurements are made while water is flowing through the at least one valve.

25. The electronic shower system of claim 20, wherein the temperature measurements are made without water flowing through the at least one valve.

26. The electronic shower system of claim 20, wherein the at least one valve comprises a mixing valve.

27. The electronic shower system of claim 20, wherein the controller is configured to calculate the current thermal time constant of the temperature measuring circuit based on temperature measurements made within a predetermined period of time.
